(19) United States
(12) Patent Application Publication
(10) Pub. No.: US 2025/0253076 A1
(43) Pub. Date: Aug. 7, 2025

(54) RESISTOR AND MANUFACTURING METHOD THEREOF

(71) Applicant: YAGEO CORPORATION, Kaohsiung City (TW)

(72) Inventors: Shen-Li HSIAO, Kaohsiung City (TW); Po-Hsun SHIH, Kaohsiung City (TW); Kuang-Cheng LIN, Kaohsiung City (TW)

(21) Appl. No.: 18/752,810

(22) Filed: Jun. 25, 2024

(30) Foreign Application Priority Data
Feb. 7, 2024 (TW) 113104984

(51) Int. Cl. H01C 7/00; H01C 1/14; H01C 17/00; H01C 17/065; H01C 17/08; H01C 17/12; H01C 17/14; H01C 17/24

(52) U.S. Cl. CPC H01C 7/006; H01C 1/14; H01C 7/003; H01C 17/003; H01C 17/0654; H01C 17/06553; H01C 17/08; H01C 17/12; H01C 17/14; H01C 17/24

(57) ABSTRACT

A resistor includes a substrate, a pair of inner electrodes, a thin-film resistive layer, a pair of backside electrodes, and a thick-film resistive layer. The substrate includes a first surface and a second surface opposite to the first surface. The pair of inner electrodes is disposed on two opposite ends of the first surface, respectively. The thin-film resistive layer is disposed on the first surface and contacts the pair of inner electrodes, wherein the thin-film resistive layer has a first resistance value and includes a trimming groove. The pair of backside electrodes is disposed on two opposite ends of the second surface, respectively. The thick-film resistive layer is disposed on the second surface and contacts the pair of backside electrodes, wherein the thick-film resistive layer has a second resistance value, and the second resistance value is greater than 100 times of the first resistance value.

### CROSS-REFERENCE TO RELATED APPLICATION

This application claims priority to Taiwan Application Serial Number 113104984, filed Feb. 7, 2024, which is herein incorporated by reference.

### BACKGROUND

### Field of Invention

The present disclosure relates to a resistor and a manufacturing method thereof.

### Description of Related Art

In the field of thin-film resistors, a design of a high-resistance circuit can usually be achieved by increasing a thickness of a thin-film resistive layer or increasing the number of curved circuit patterns. However, when the number of curved circuit patterns increases, the distance between two adjacent circuits is too close, which can easily cause too large electric field between the circuits and then cause electrostatic discharge (ESD), thereby resulting in ESD damage.

In the field of thick-film resistors, a design of a high-resistance circuit can usually be achieved by using a laser cutting processing after forming a thick-film resistive layer. In order to reduce ESD damage, a thickness of the thick-film resistive layer can be increased or a pattern of a laser cutting process can be finely adjusted, so as to reduce a surface current density of the thick-film resistive layer, thereby achieving the effect of anti-ESD. However, since a material of the thick-film resistive layer is glass material and semiconductor material, the thick-film resistive layer may easily cause a micro short circuit when ESD is present.

For the foregoing reason, there is a need to solve the above-mentioned problems by providing a resistor and a manufacturing method thereof.

### SUMMARY

A thin-film resistive layer and a thick-film resistive layer of the disclosed resistor respectively are disposed on opposite sides of a substrate. Since the thick-film resistive layer has the dielectric property of glass, it can be used as an absorption layer of ESD and surge voltage to achieve the effect of protecting the thin-film resistive layer, such that the thin-film resistive layer is endowed with high precision and high-stability electrical properties. In addition, the disclosed resistor (i.e., one resistor having both the thin-film resistive layer and the thick-film resistive layer) of the disclosed structure has the resistance characteristics of high-thermal conductivity, high-surge absorption, and high-stable reliability.

In at least one embodiment of the present disclosure, a resistor is provided. The resistor includes a substrate, a pair of inner electrodes, a thin-film resistive layer, a pair of backside electrodes, and a thick-film resistive layer. The substrate includes a first surface and a second surface opposite to the first surface. The pair of inner electrodes is disposed on two opposite ends of the first surface, respectively. The thin-film resistive layer is disposed on the first surface and contacts the pair of inner electrodes, in which the thin-film resistive layer has a first resistance value and includes a trimming groove. The pair of backside electrodes is disposed on two opposite ends of the second surface, respectively. The thick-film resistive layer is disposed on the second surface and contacts the pair of backside electrodes, in which the thick-film resistive layer has a second resistance value, and the second resistance value is greater than 100 times of the first resistance value.

In at least one embodiment of the present disclosure, the second resistance value is less than 10000 times of the first resistance value.

In at least one embodiment of the present disclosure, a material of the thin-film resistive layer is NiCr, CuNi, NiCrSi, NiCrAl, NiCrAlSi, NiCrAlY, NiCrTaMo, TaN, CuMnSn, CuMnNi, or Au.

In at least one embodiment of the present disclosure, a thickness of the thin-film resistive layer is less than 3 micrometers.

In at least one embodiment of the present disclosure, a material of the thick-film resistive layer is a mixture of ruthenium oxide, silver, and glass.

In at least one embodiment of the present disclosure, a thickness of the thick-film resistive layer is greater than 10 micrometers.

In at least one embodiment of the present disclosure, the resistor further includes a passivation layer. The passivation layer conformally covers the thin-film resistive layer and covers a sidewall of the thin-film resistive layer, in which a thickness of the passivation layer is in a range from 0.2 micrometers to 3 micrometers.

In at least one embodiment of the present disclosure, the passivation layer contacts the pair of inner electrodes.

In at least one embodiment of the present disclosure, a material of the passivation layer includes silicon oxide, tantalum oxide, or silicon nitride.

In at least one embodiment of the present disclosure, the resistor further includes a first protection layer, a second protection layer, a third protection layer, and a pair of external electrodes. The first protection layer covers the thin-film resistive layer. The second protection layer covers the thick-film resistive layer. The third protection layer covers the second protection layer. The pair of external electrode electrically connects the pair of inner electrodes and the pair of backside electrodes.

In at least one embodiment of the present disclosure, a material of the first protection layer is epoxy or resin.

In at least one embodiment of the present disclosure, a material of the second protection layer includes SiO₂, MgO, TiO₂, and inorganic compounds.

In at least one embodiment of the present disclosure, a material of the third protection layer is epoxy or resin.

In at least one embodiment of the present disclosure, a manufacturing method of a resistor is provided. A substrate is provided, in which the substrate includes a first surface and a second surface opposite to the first surface. A pair of inner electrodes is formed on two opposite ends of the first surface, respectively. A pair of backside electrodes is formed on two opposite ends of the second surface, respectively. The thick-film resistive layer is formed on the second surface and contacts the pair of backside electrodes. The thin-film resistive layer is formed on the first surface and contacts the pair of inner electrodes. A trimming operation is performed on the thin-film resistive layer. The passivation layer is conformally performed on the thin-film resistive layer, in which the passivation layer further covers a sidewall of the thin-film resistive layer. A pair of external electrode is formed on two opposite sides of the substrate, respectively, in which the pair of external electrodes electrically connects the pair of inner electrodes and the pair of backside electrodes, the thin-film resistive layer has a first resistance value, the thick-film resistive layer has a second resistance value, and the second resistance value is greater than 100 times of the first resistance value.

In at least one embodiment of the present disclosure, the manufacturing method of the resistor further includes: after forming the thick-film resistive layer, forming a first protection layer on the thick-film resistive layer.

In at least one embodiment of the present disclosure, the manufacturing method of the resistor further includes: after conformally forming the passivation layer, forming a second protection layer on the passivation layer, and forming a third protection layer on the first protection layer.

In at least one embodiment of the present disclosure, the first protection layer is formed by printing and sintering, the second protection layer is formed by printing or photolithography, and the third protection layer is formed by printing or photolithography.

In at least one embodiment of the present disclosure, the thick-film resistive layer is formed by printing and sintering, and the thin-film resistive layer is formed by sputtering or chemical vapor deposition.

In at least one embodiment of the present disclosure, the trimming operation includes an etching operation.

In at least one embodiment of the present disclosure, the passivation layer is formed by sputtering or chemical vapor deposition.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a cross-sectional view of a resistor according to one embodiment of the present disclosure.

FIG. 2A, FIG. 3A, FIG. 4A, FIG. 5A, FIG. 6A, and FIG. 7A are cross-sectional views of the resistor in FIG. 1 at various process stages.

FIG. 2B, FIG. 3B, and FIG. 7C are bottom views of FIG. 2A, FIG. 3A, and FIG. 7A, respectively.

FIG. 4B, FIG. 5B, FIG. 6B, and FIG. 7B are top views of FIG. 4A, FIG. 5A, FIG. 6A, and FIG. 7A, respectively.

### DETAILED DESCRIPTION

The following disclosure provides many different embodiments, or examples, for implementing different features of the present disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The device may be otherwise oriented (rotated 90 degrees or at other orientations) and the spatially relative descriptors used herein may likewise be interpreted accordingly.

It will be understood that, in the description herein and throughout the claims that follow, although the terms “first,” “second,” etc. may be used to describe various elements, these elements should not be limited by these terms. These terms are only used to distinguish one element from another. For example, a first element could be termed a second element, and, similarly, a second element could be termed a first element, without departing from the scope of the embodiments. It will be understood that, in the description herein and throughout the claims that follow, the term “and/or” includes any and all combinations of one or more of the associated listed items.

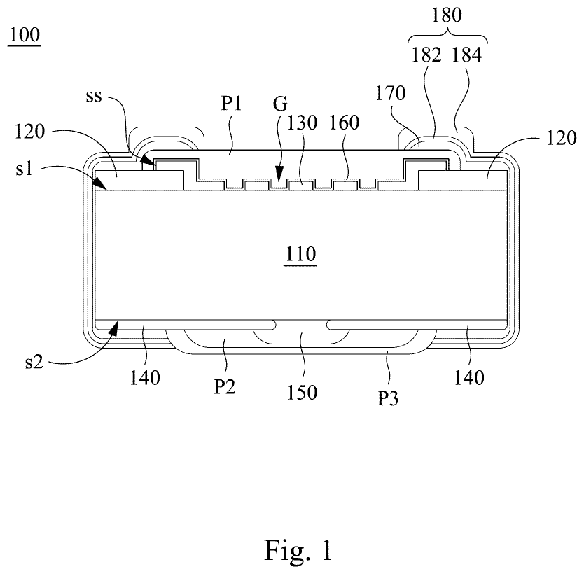

FIG. 1 is a cross-sectional view of a resistor 100 according to one embodiment of the present disclosure. The resistor 100 includes a substrate 110, a pair of inner electrodes 120, and a thin-film resistive layer 130. The substrate 110 includes a first surface s1 and a second surface s2, in which the second surface s2 is opposite to the first surface s1. The pair of inner electrodes 120 is disposed on two opposite ends of the first surface s1, respectively. The thin-film resistive layer 130 is disposed on the first surface s1 and contacts the pair of inner electrodes 120. Specifically, the thin-film resistive layer 130 further covers portions of the inner electrodes 120, such that the thin-film resistive layer 130 is across the pair of inner electrodes 120. In other words, a portion of each of the pair of inner electrodes 120 is disposed between the thin-film resistive layer 130 and the substrate 110.

As shown in FIG. 1, the thin-film resistive layer 130 includes a plurality of trimming grooves G. It is worth noting that FIG. 1 illustrates four trimming grooves, but the number of the trimming grooves can be adjusted according to actual resistance requirements and is not limited to the number shown in FIG. 1.

In some embodiments, a thickness of the thin-film resistive layer 130 is less than 3 micrometers, for example, 0.1 or 0.2 micrometers.

Still referring to FIG. 1, the resistor 100 further includes a pair of backside electrodes 140 and a thick-film resistive layer 150. The pair of backside electrodes 140 is disposed on two opposite ends of the second surface s2, respectively. The thick-film resistive layer 150 is disposed on the second surface s2 and contacts the pair of backside electrodes 140. Specifically, the thick-film resistive layer 150 further covers portions of the backside electrodes 140, such that the thick-film resistive layer 150 is across the pair of backside electrodes 140. In other words, a portion of each of the pair of backside electrodes 140 is disposed between the thick-film resistive layer 150 and the substrate 110. A material of the thick-film resistive layer 150 includes glass. Therefore, the thick-film resistive layer 150 has the dielectric property of glass.

In some embodiments, a thickness of the thick-film resistive layer 150 is greater than 10 micrometers, for example, 10 to 20 micrometers.

Still referring to FIG. 1, the resistor 100 further includes a passivation layer 160. The passivation layer 160 conformally covers the thin-film resistive layer 130 and covers a sidewall ss of the thin-film resistive layer 130. Specifically, the passivation layer 160 further covers bottom surfaces and side surfaces of the plurality of trimming grooves G. If the passivation layer 160 covers the sidewall ss of the thin-film resistive layer 130 and the bottom surfaces and the side surfaces of the trimming grooves G, moisture can be prevented entering the thin-film resistive layer 130 from the outside, thereby avoiding the damage of the resistor 100.

In some embodiments, a thickness of the passivation layer 160 is in a range from 0.2 micrometers to 3 micrometers, for example, 0.5, 1, 1.5, 2, or 2.5 micrometers. If the thickness of the passivation layer 160 is less than 0.2 micrometers, the underlying thin-film resistive layer 130 could not be protected. If the thickness of the passivation layer 160 is greater than 3 micrometers, it would not have advantages to the overall resistor 100. It is worth noting that the existence of the passivation layer 160 is advantageous to form a side connection layer 170 and a pair of external electrodes 180 at the subsequent process, and avoid a short circuit of the resistor.

Still referring to FIG. 1, the resistor 100 further includes a protection layer P1, a protection layer P2, a protection layer P3, a side connection layer 170, and a pair of external electrodes 180, in which the external electrodes 180 electrically connects the inner electrodes 120 and the backside electrodes 140. The protection layer P1 covers the thin-film resistive layer 130. The protection layer P2 covers the thick-film resistive layer 150. The protection layer P3 covers the protection layer P2. The side connection layer 170 covers the inner electrodes 120 and the backside electrodes 140. The external electrodes 180 includes a nickel layer 182 and a tin(Sn) layer 184, in which the nickel layer 182 covers the side connection layer 170, and the tin layer 184 covers the nickel layer 182.

In the resistor 100 of FIG. 1, the thin-film resistive layer 130 has a first resistance value, the thick-film resistive layer 150 has a second resistance value, and the second resistance value is greater than 100 times of the first resistance value. In some embodiments, the second resistance value is less than 10000 times of the first resistance value. For example, the second resistance value is 1000, 2000, 5000, or 8000 times less than the first resistance value.

The thin-film resistive layer 130 and the thick-film resistive layer 150 respectively are disposed on opposite sides of the substrate 110. Therefore, the thin-film resistive layer 130 and the thick-film resistive layer 150 can be understood to be arranged in parallel connection. The second resistance value of the thick-film resistive layer 150 is greater than 100 times of the first resistance value of the thin-film resistive layer 130. According to Ohm's Law and the principle of voltage division, if ESD or a surge voltage exists, the second resistance value of the thick-film resistive layer 150 will withstand a greater voltage difference and a power impact compared to the first resistance value of the thin-film resistive layer 130. According to basic rules of parallel circuit, if the second resistance value of the thick-film resistive layer 150 is damaged and changed, it will have little impact on an overall resistance value of the resistor 100. Therefore, the characteristics of the thin-film resistive layer are still good. In other words, if the second resistance value was less than 100 times of the first resistance value, the characteristics of the thin-film resistive layer would not be retained. Furthermore, because the thick-film resistive layer 150 has the dielectric property of glass and has pores in the thick-film resistive layer 150, the thick-film resistive layer 150 tends to absorb ESD compared to the thin-film resistive layer 130.

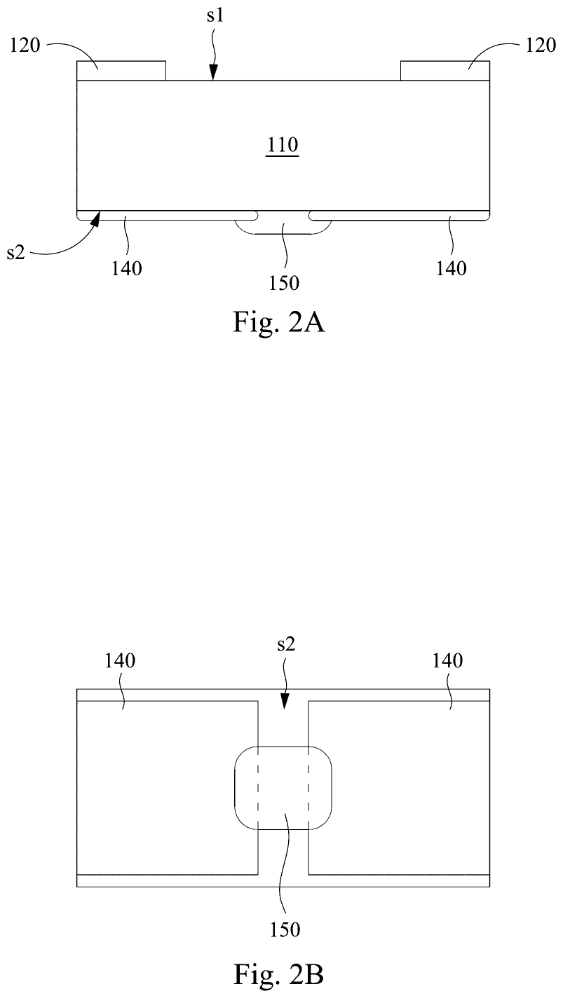

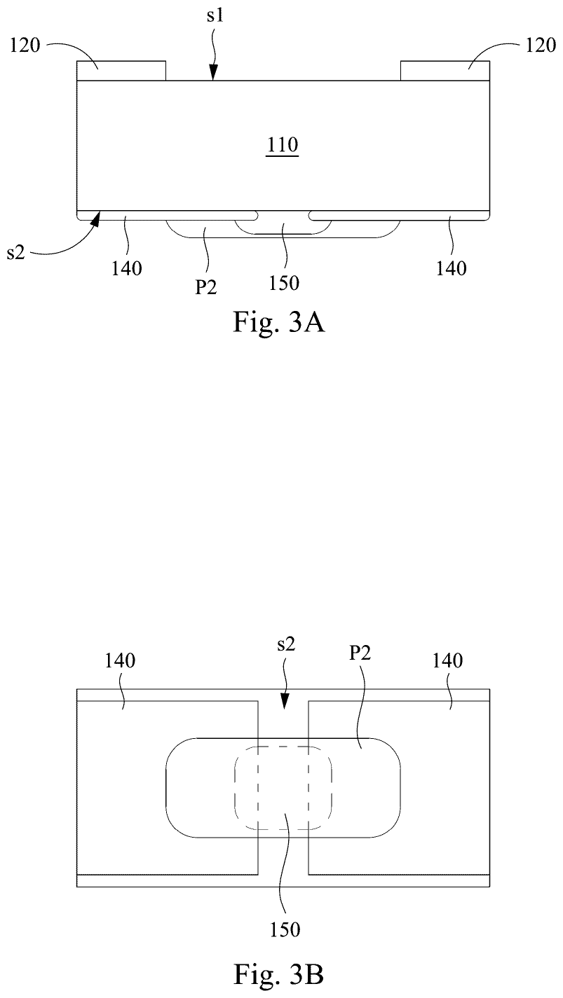

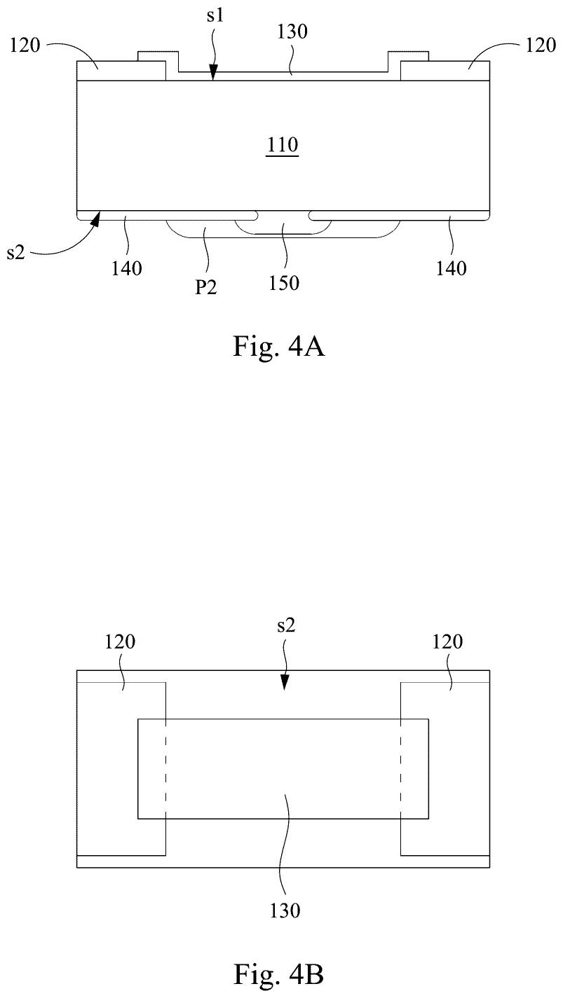

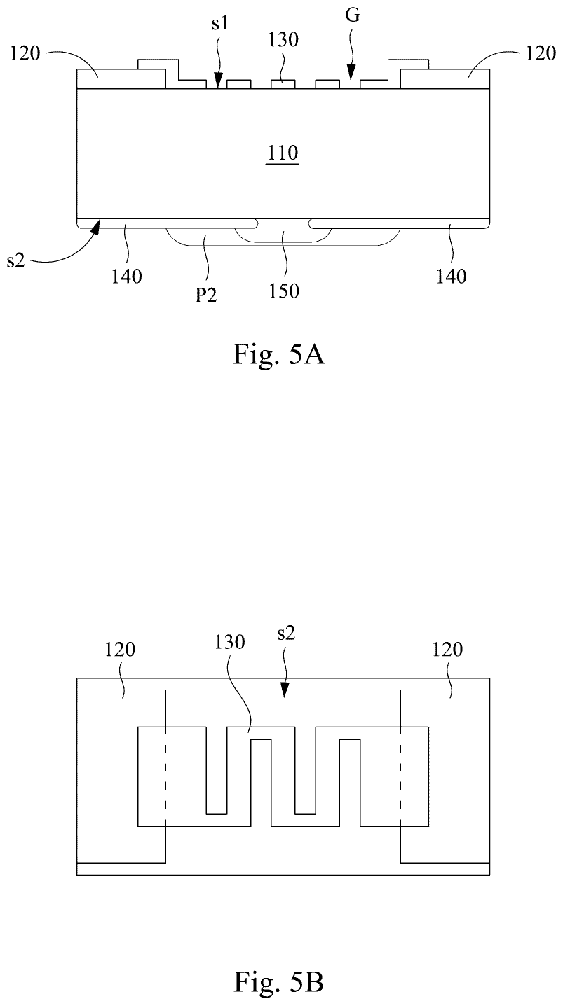

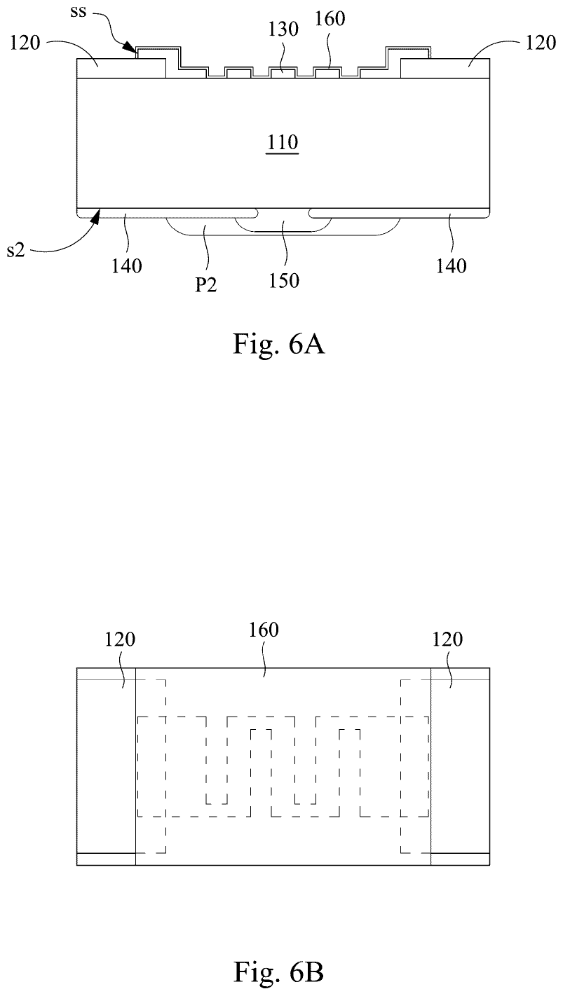

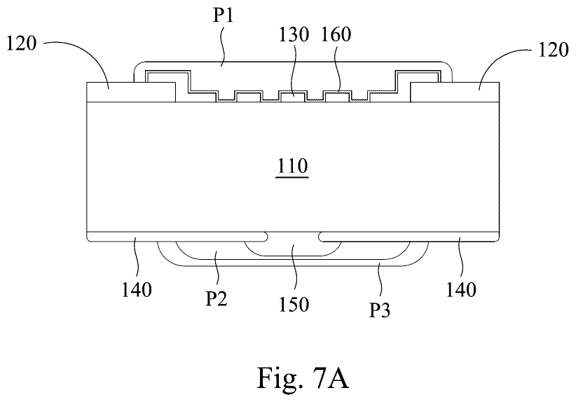

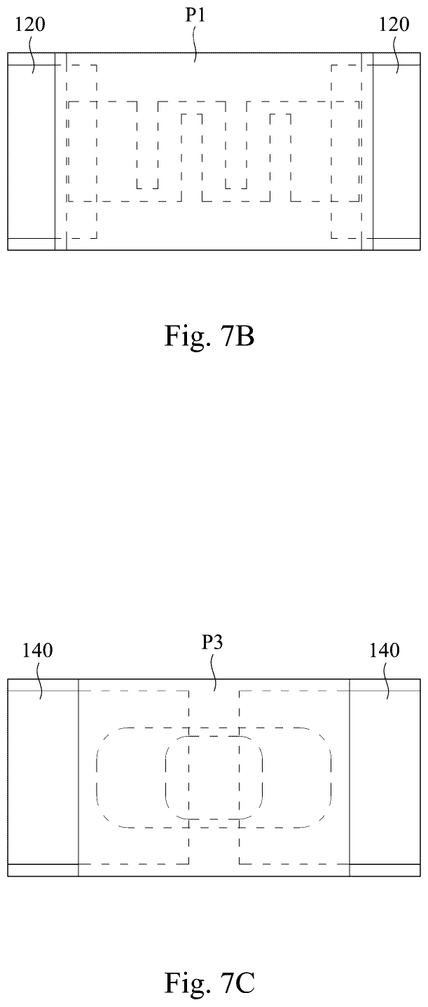

FIG. 2A, FIG. 3A, FIG. 4A, FIG. 5A, FIG. 6A, and FIG. 7A are cross-sectional views of the resistor 100 in FIG. 1 at various process stages. FIG. 2B, FIG. 3B, and FIG. 7C are bottom views of FIG. 2A, FIG. 3A, and FIG. 7A, respectively. FIG. 4B, FIG. 5B, FIG. 6B, and FIG. 7B are top views of FIG. 4A, FIG. 5A, FIG. 6A, and FIG. 7A, respectively.

Referring to FIG. 2A, the pair of inner electrodes 120 is formed on two opposite ends of the first surface s1 of the substrate 110, respectively. Referring to FIG. 2A and FIG. 2B, the pair of backside electrodes 140 is formed on two opposite ends of the second surface s2 of the substrate 110, respectively. In some embodiments, materials of the inner electrodes 120 and the backside electrodes 140 are an electrode pastes containing glass, silver, or silver palladium.

As shown in FIG. 2A and FIG. 2B, after the backside electrodes 140 are formed, the thick-film resistive layer 150 is formed on the second surface s2, in which the thick-film resistive layer 150 contacts the backside electrodes 140. In the embodiment of FIG. 2A and FIG. 2B, the thick-film resistive layer 150 is formed by printing and sintering, in which a sintering temperature is greater than 600° C. In some embodiments, materials of the thick-film resistive layer 150 are a mixture of ruthenium oxide, silver, and glass, but are not limited to the above-mentioned the material of printed resistor paste. The composition ratio of the materials of the thick-film resistive layer 150 is well known in this art and will not be described here.

Referring to FIG. 3A and FIG. 3B, after the thick-film resistive layer 150 is formed, the protection layer P2 is formed on the thick-film resistive layer 150, in which the protection layer P2 further covers portions of the backside electrodes 140. The protection layer P2 is formed by printing and sintering. In some embodiments, materials of the protection layer P2 are a glass mixture of SiO₂, MgO, TiO₂, and inorganic compounds. The composition ratio of the materials of the protection layer P2 is well known in this art and will not be described here.

Referring to FIG. 4A and FIG. 4B, the thin-film resistive layer 130 is formed on the first surface s1 of the substrate 110, in which the thin-film resistive layer 130 contacts the inner electrodes 120. The thin-film resistive layer 130 is formed by sputtering or chemical vapor deposition, in which an operation temperature is less than 200° C. In some embodiments, a material of the thin-film resistive layer 130 includes NiCr, CuNi, NiCrSi, NiCrAl, NiCrAlSi, NiCrAlY, NiCrTaMo, TaN, CuMnSn, CuMnNi, Au, or combinations thereof, but is not limited thereto.

Referring to FIG. 5A and FIG. 5B, after the thin-film resistive layer 130 is formed, a trimming operation is performed on the thin-film resistive layer 130, so that the plurality of trimming grooves G are formed, in which the trimming grooves G expose the first surface s1 of the substrate 110. In some embodiments, the trimming grooves G are formed by etching.

Referring to FIG. 6A and FIG. 6B, the passivation layer 160 is conformally formed on the thin-film resistive layer 130, in which the passivation layer 160 further covers the sidewall ss of the thin-film resistive layer 130. In other words, the passivation layer 160 contacts the inner electrodes 120. The passivation layer 160 is formed by sputtering or chemical vapor deposition. In some embodiments, the passivation layer 160 may be an insulating protective film including silicon oxide, tantalum oxide, silicon nitride, or the like.

Referring to FIG. 7A and FIG. 7B, after the passivation layer 160 is formed, the protection layer P1 is formed on the passivation layer 160, in which the protection layer P1 further covers portions of the inner electrodes 120. In some embodiments, the protection layer P1 is formed by printing or photolithography. In some embodiments, a material of the protection layer P1 is epoxy or general resin.

Referring to FIG. 7A and FIG. 7C, after the protection layer P2 is formed, the protection layer P3 is formed on the protection layer P2, in which the protection layer P3 further cover portions of the backside electrodes 140. In some embodiments, the protection layer P3 is formed by printing or photolithography. In some embodiments, a material of the protection layer P3 is epoxy or general resin.

Subsequently, referring to FIG. 1, the side connection layer 170, the nickel layer 182, and the tin layer 184 are formed respectively. The side connection layer 170 is formed by sputtering. The nickel layer 182 and tin layer 184 are formed by electroplating.

In the resistor 100 of the present disclosure, the thick-film resistive layer 150 is formed first, and then the thin-film resistive layer 130 is formed. This is because the process temperature (greater than 600° C.) of the thick-film resistive layer 150 is greater than the process temperature (less than 200° C.) of the thin-film resistive layer 130.

In summary, the thin-film resistive layer and the thick-film resistive layer of the disclosed resistor are disposed on opposite sides of the substrate. Since the thick-film resistive layer has the dielectric property of glass, it can be used as an absorption layer of ESD and surge voltage to achieve the effect of protecting the thin-film resistive layer, such that the thin-film resistive layer is endowed with high-precision and high-stability electrical properties. In addition, the disclosed resistor (i.e., one resistor having both the thin-film resistive layer and the thick-film resistive layer) of the disclosed structure has the resistance characteristics of high-thermal conductivity, high-surge absorption, and high-stable reliability.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A resistor, comprising:
a substrate comprising a first surface and a second surface opposite to the first surface;
a pair of inner electrodes disposed on two opposite ends of the first surface, respectively;
a thin-film resistive layer disposed on the first surface and contacting the pair of inner electrodes, wherein the thin-film resistive layer has a first resistance value and comprises a trimming groove;
a pair of backside electrodes disposed on two opposite ends of the second surface, respectively; and
a thick-film resistive layer disposed on the second surface and contacting the pair of the backside electrodes, wherein the thick-film resistive layer has a second resistance value, and the second resistance value is greater than 100 times of the first resistance value.

2. The resistor of claim 1, wherein the second resistance value is less than 10000 times of the first resistance value.

3. The resistor of claim 1, wherein a material of the thin-film resistive layer is NiCr, CuNi, NiCrSi, NiCrAl, NiCrAlSi, NiCrAlY, NiCrTaMo, TaN, CuMnSn, CuMnNi, or Au.

4. The resistor of claim 1, wherein a thickness of the thin-film resistive layer is less than 3 micrometers.

5. The resistor of claim 1, wherein a material of the thick-film resistive layer is a mixture of ruthenium oxide, silver, and glass.

6. The resistor of claim 1, wherein a thickness of the thick-film resistive layer is greater than 10 micrometers.

7. The resistor of claim 1, further comprising:
a passivation layer conformally covering the thin-film resistive layer and covering a sidewall of the thin-film resistive layer, wherein a thickness of the passivation layer is in a range from 0.2 micrometers to 3 micrometers.

8. The resistor of claim 7, wherein the passivation layer contacts the pair of inner electrodes.

9. The resistor of claim 7, wherein a material of the passivation layer comprises silicon oxide, tantalum oxide, or silicon nitride.

10. The resistor of claim 1, further comprising:
a first protection layer covering the thin-film resistive layer;
a second protection layer covering the thick-film resistive layer;
a third protection layer covering the second protection layer; and
a pair of external electrodes electrically connecting the pair of inner electrodes and the pair of backside electrodes.

11. The resistor of claim 10, wherein a material of the first protection layer is epoxy or resin.

12. The resistor of claim 10, wherein a material of the second protection layer comprises SiO₂, MgO, TiO₂, and inorganic compounds.

13. The resistor of claim 10, wherein a material of the third protection layer is epoxy or resin.

14. A manufacturing method of a resistor, comprising:
providing a substrate, wherein the substrate comprises a first surface and a second surface opposite to the first surface;
forming a pair of inner electrodes on two opposite ends of the first surface, respectively;
forming a pair of backside electrodes on two opposite ends of the second surface, respectively;
forming a thick-film resistive layer on the second surface, wherein the thick-film resistive layer contacts the pair of the backside electrodes;
forming a thin-film resistive layer on the first surface, wherein the thin-film resistive layer contacts the pair of the inner electrodes;
performing a trimming operation on the thin-film resistive layer;
conformally forming a passivation layer on the thin-film resistive layer, wherein the passivation layer further covers a sidewall of the thin-film resistive layer; and
forming a pair of external electrodes on two opposite sides of the substrate, respectively, wherein the pair of external electrodes electrically connects the pair of inner electrodes and the pair of backside electrodes, the thin-film resistive layer has a first resistance value, the thick-film resistive layer has a second resistance value, and the second resistance value is greater than 100 times of the first resistance value.

15. The manufacturing method of the resistor of claim 14, further comprising:
after forming the thick-film resistive layer, forming a first protection layer on the thick-film resistive layer.

16. The manufacturing method of the resistor of claim 15, further comprising:
after conformally forming the passivation layer, forming a second protection layer on the passivation layer; and
forming a third protection layer on the first protection layer.

17. The manufacturing method of the resistor of claim 16, wherein the first protection layer is formed by printing and sintering, the second protection layer is formed by printing or photolithography, and the third protection layer is formed by printing or photolithography.

18. The manufacturing method of the resistor of claim 14, wherein the thick-film resistive layer is formed by printing and sintering, and the thin-film resistive layer is formed by sputtering or chemical vapor deposition.

19. The manufacturing method of the resistor of claim 14, wherein the trimming operation comprises an etching operation.

20. The manufacturing method of the resistor of claim 14, wherein the passivation layer is formed by sputtering or chemical vapor deposition.
